(19) United States
(12) Patent Application Publication
(10) Pub. No.: US 2025/0059883 A1
(43) Pub. Date: Feb. 20, 2025

(54) MONITORING SYSTEM AND METHOD

(71) Applicant: Orica International Pte Ltd, Singapore (SG)

(72) Inventors: Rodney APPLEBY, Singapore (SG); Kieren RASMUSSEN, Singapore (SG); John ARKWRIGHT, Singapore (SG)

(21) Appl. No.: 18/712,568

(22) PCT Filed: Nov. 24, 2022
(86) PCT No.: PCT/SG2022/050856

§ 371 Date: May 22, 2024

(30) Foreign Application Priority Data
Nov. 25, 2021 (SG) 10202113093T

(51) Int. Cl. E21B 47/047; E21B 47/09; F42D 1/10; G01F 23/14

(52) U.S. Cl. CPC E21B 47/047; E21B 47/09; F42D 1/10; G01F 23/14

(57) ABSTRACT

A system, including for automatically detecting, monitoring and/or controlling loading of explosive material in a borehole during commercial blasting operations, including: a sensor component with a sensor element including at least one sensor configured to automatically determine a depth of the sensor element in fluid explosive material in a borehole; and a depth component configured to automatically determine a relative depth of the sensor element in the borehole relative to a fluid outlet while the fluid outlet is loading the fluid explosive material in the borehole.

### RELATED APPLICATION

The present application is related to Singapore Patent Application No. 10202113093T, filed 25 Nov. 2021, the originally filed specification of which is hereby incorporated herein by reference in its entirety.

### TECHNICAL FIELD

The present disclosure relates to systems and methods/processes for automatically detecting, monitoring and/or controlling loading of explosive material in a borehole during commercial blasting operations.

### BACKGROUND

In commercial blasting operations, boreholes are loaded with explosive material, including fluid explosive material (e.g., emulsion), prior to blasting.

Using existing technologies, it may be difficult to determine how quickly and how well the explosive products are filling the boreholes, including due to non-uniform borehole shapes (including for example variable cross sections, variable straightness, undesirable voids if the explosive products are filled too quickly, irregularities or cracks in the borehole walls, loose rock in the borehole, etc.), due to water in the boreholes floating on top of the emulsion, due to very deep narrow boreholes, and/or due to the stickiness of fluid explosive products, etc. In addition, some explosive products are “gassed”, and depending on the state of these explosive products in the borehole, the volume occupied by these gassed explosive products in the borehole may vary with time.

For example, boreholes are traditionally charged with Ammonium Nitrate Bulk Emulsion (ANE)-based explosives by positioning a fluid outlet (i.e., the outlet for the fluid explosive material from a hose/pipe/tube) close to the end of the borehole (e.g., the bottom end in a downhole), starting the flow of ANE, and gradually withdrawing the fluid outlet out of the borehole: to maintain a consistent column, it is desirable to withdraw the hose/pipe/tube at a draw rate which maintains the fluid outlet in the ANE throughout the fill, which is difficult in deep/long and/or water-filled boreholes, and traditionally relies on operator “experience” as no appropriate monitoring tools have been available.

It is desired to address or ameliorate one or more disadvantages or limitations associated with the prior art, or to at least provide a useful alternative.

### SUMMARY

Disclosed herein is a system 100 (for automatically monitoring loading of fluid explosive material 102 into a borehole 104 via a fluid outlet 106 during commercial blasting operations), the system 100 including:
a. a sensor component 108 with a sensor element 122 including at least one sensor configured to automatically determine a depth (B “sensor element depth”) of the sensor element 122 in the fluid explosive material 102 in the borehole 104; and
b. a depth component configured to automatically determine (e.g., fix/set/select or monitor/measure/sense) a relative depth (R) of the sensor element 122 in the borehole 104 relative to the fluid outlet 106 while the fluid outlet 106 is loading the fluid explosive material 102 in the borehole 104.

The system 100 may be configured to automatically determine a depth (D “the outlet depth”) of the fluid outlet 106 in the fluid explosive material 102 based on the sensor element depth (B) and the relative depth (R).

The sensor element 122 may be configured to be at least partially immersed in the fluid explosive material 102 in use.

The sensor element 122 may be configured to distinguish between the fluid explosive material 102 and another fluid 114 in the borehole 104 to determine the sensor element depth B of the sensor element 122 in the fluid explosive material 102. The fluid explosive material 102 may be referred to as a “first fluid”, and the other fluid 114 may be referred to as a “second fluid”.

The fluid explosive material 102 (“first fluid”) may have an (average) first fluid density (ρ1), and the other fluid 114 (“second fluid”) may have an (average) second fluid density (ρ2). The second fluid density (ρ2) may be measurably different from the first fluid density (ρ1). The other fluid 114 may include another fluid explosive material (e.g., an explosive emulsion), water and/or air.

The sensor element 122 includes at least one sensor. The sensor element 122 may include just one sensor; or a plurality of sensors, including two sensors or more than two sensors. The sensor element 122 may include the plurality of the sensors mutually aligned on or distributed along an axis to form a sensor array. Each sensor may be configured to distinguish between the fluid explosive material 102 (“first fluid”) and the other fluid 114 (“second fluid”). The sensor element 122 may include two or more sensor components (operating in parallel and/or for redundancy), including one or more single-sensor components (mono-sensor component), one or more two-sensor components (dual-sensor component) and/or one or more array component, with the system 100 being configured to combine respective measurements from the two or more sensor components statistically (e.g., by averaging and/or rejecting outlier values) during operation.

The sensor element 122 and the sensors are configured to measure the values of at least one fluid property or measured characteristic of the explosive material 102 and of the other fluid 114. The system may be configured to determine the sensor element depth based on the measured values. The at least one fluid property/characteristic may be in the form of a macroscopic physical property, which is a property of the bulk fluid and not of a thin layer, that is thus not affected by layers of fouling on the sensor element 122 or the sensors. The macroscopic physical property may include pressures exerted/applied by the fluid explosive material 102 and/or by the other fluid 114 to the sensor element 122 and the sensors. The sensors may include pressure sensors. When the sensor element 122 forms a sensor array, the pressure sensors may be configured in the sensor array to measure at least one pressure gradient along the sensor array. The at least one pressure gradient may include a plurality of pressure gradients corresponding to a plurality of fluid densities, which may include the average first fluid density ρ1 and the average second fluid density ρ2 respectively (corresponding to the fluid explosive material 102 and the other fluid 114 applying pressure to the sensor element 122). The at least one pressure gradient may include a pressure difference between two mutually spaced sensors in the sensor element 122, wherein the two mutually spaced sensors may be provided by a single differential pressure sensor aligned along the sensor element 122. When the sensor element 122 includes only one sensor, the sensor may be configured to measure a pressure at one point/level along the sensor element 122.

The depth component may be configured to automatically determine the relative depth (R) by: fixing/setting/selecting the relative depth (R); or monitoring/measuring/sensing the relative depth (R).

Disclosed herein is a method (or “process”, for automatically monitoring loading of fluid explosive material 102 into a borehole 104 via a fluid outlet 106 during commercial blasting operations), the method including:
a. determining a depth (B) (“sensor element depth”) of a sensor element 122 in the fluid explosive material 102 in the borehole 104; and
b. automatically determining (e.g., fixing/setting/selecting or monitoring/measuring/sensing) a relative depth (R) of the sensor element 122 in the borehole 104 relative to the fluid outlet 106 while the fluid outlet 106 is loading the fluid explosive material 102 in the borehole 104.

The method may include automatically determine a depth (“the outlet depth”) of the fluid outlet 106 in the fluid explosive material 102 based on the sensor element depth (B) and the relative depth (R).

The method may include partially immersing the sensor element 122 in the fluid explosive material 102.

The method may include automatically distinguishing between the fluid explosive material 102 and another fluid 114 (“other fluid”) in the borehole 104 to determine the sensor element depth (B). The method may include automatically performing the distinguishing between sensor element the fluid explosive material 102 and the other fluid 114 at a plurality of sensing locations along the sensor element 122.

The method may include measuring values of at least one fluid property of the explosive material 102 and of the other fluid 114, and automatically determining the sensor element depth (B) based on the measured values. The values of the at least one fluid property may be in the form of a macroscopic physical property that is not affected by layers of fouling on the sensor element 122. The macroscopic physical property may include pressures exerted/applied by the fluid explosive material 102 and/or by the other fluid 114 to the sensor element 122. The method may include measuring a pressure gradient along the sensor element 122.

The method may include automatically determining the relative depth (R) by: fixing/setting/selecting the relative depth (R); or monitoring/measuring/sensing the relative depth (R).

The system 100 includes analysis/control modules 820 configured/arranged to control the system 100 to perform the methods described hereinbefore.

### BRIEF DESCRIPTION OF THE DRAWINGS

Some embodiments of the present invention are hereinafter described, by way of non-limiting example only, with reference to the accompanying drawings, in which:

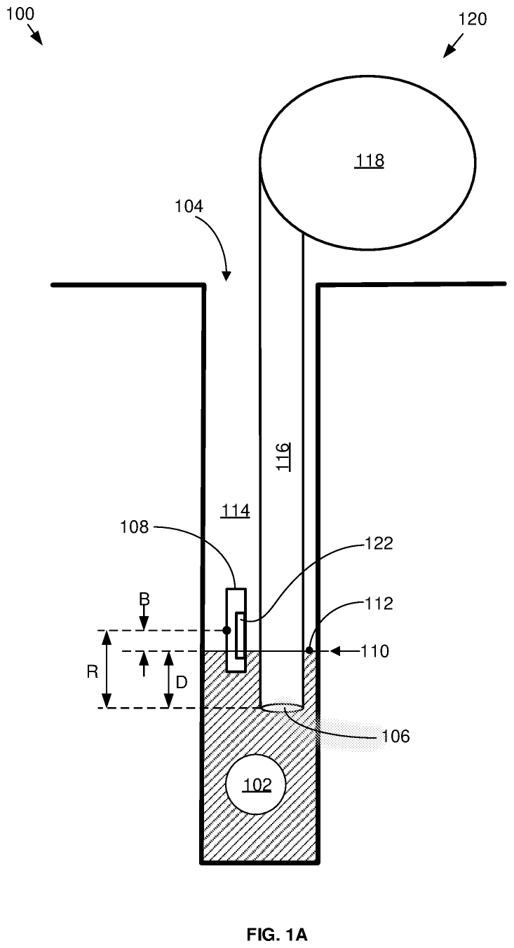

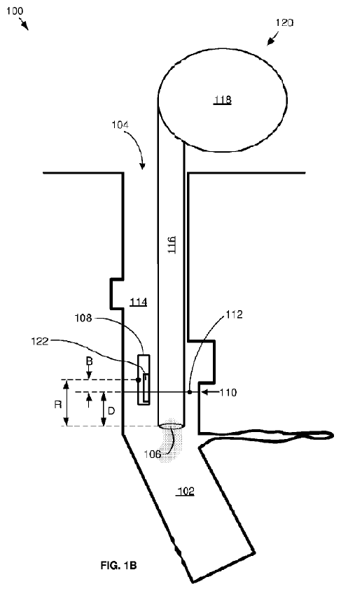

a. FIG. 1A is a cross-sectional side diagram of a system with a sensor component and a hose/pipe/tube described herein in a borehole with a fluid explosive;

b. FIG. 1B is a cross-sectional side diagram of the system described herein in an alternative borehole with a fluid explosive;

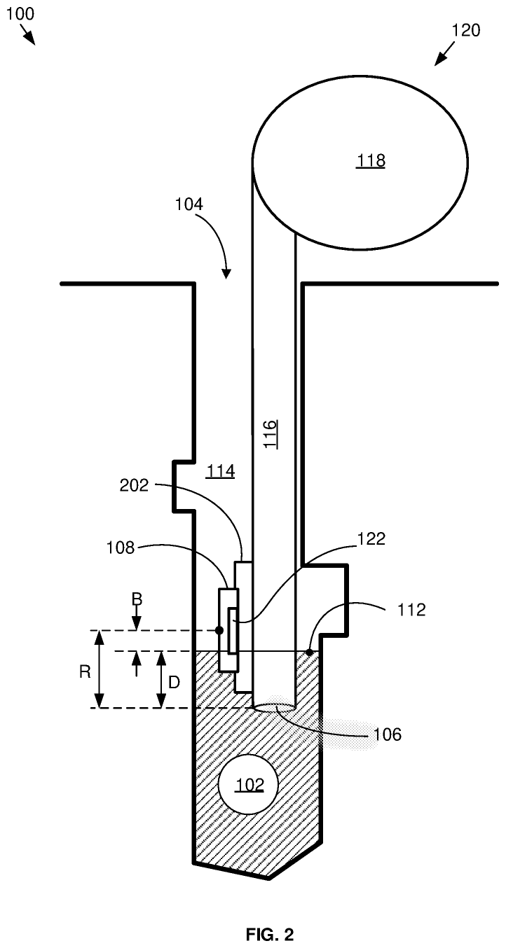

c. FIG. 2 is a cross-sectional side diagram of the system including a mount for the sensor component;

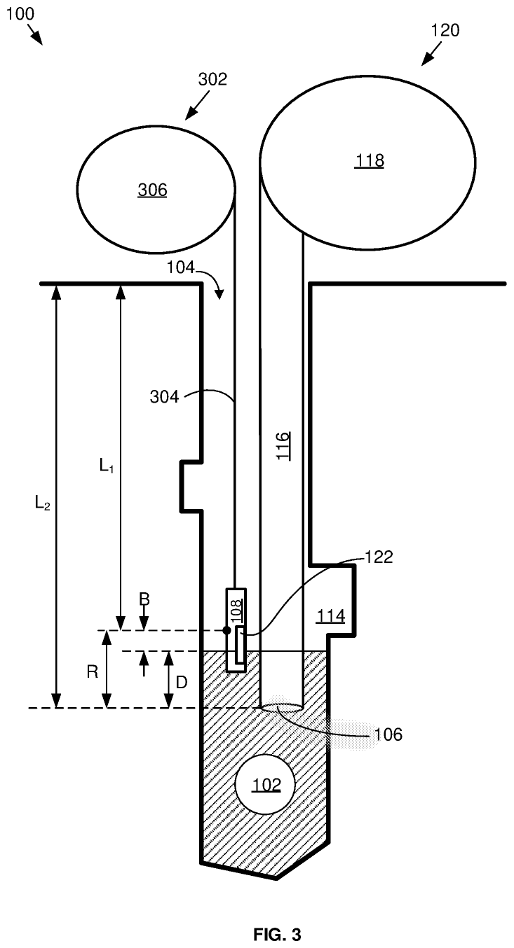

d. FIG. 3 is a cross-sectional side diagram of the system including an independent mechanical apparatus for the sensor component, movable independently from the hose/pipe/tube, and electrically linked/connected to the hose/pipe/tube by a system controller;

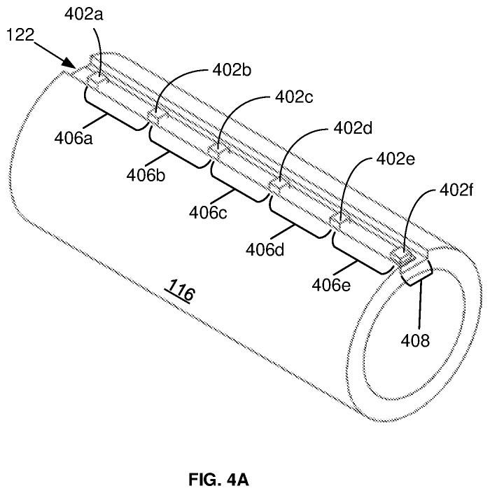

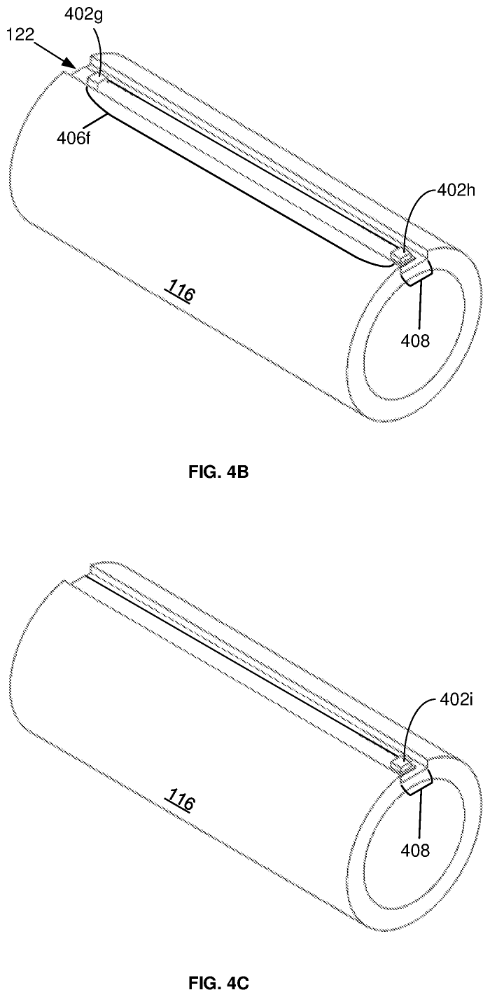

e. FIGS. 4A to 4C are end perspective diagrams of different versions of the sensor component affixed to the hose/pipe/tube;

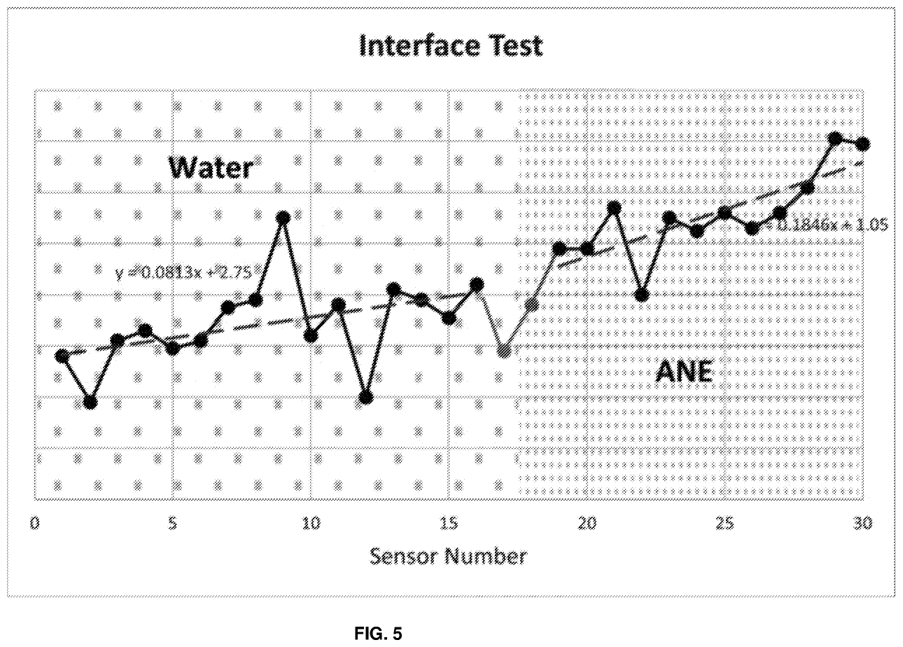

f. FIG. 5 is a graph of sensor measurement (of pressure) versus sensor location (on the sensor component) for example measurements from an exemplary implementation of the system;

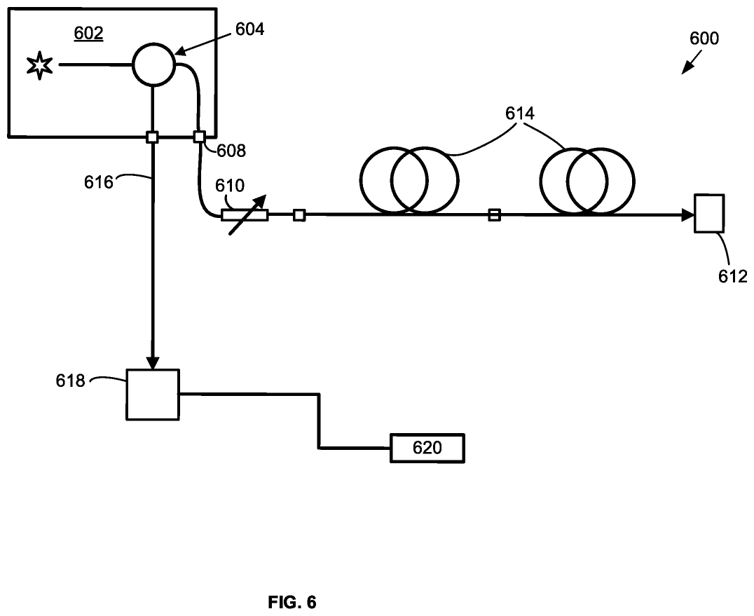

g. FIG. 6 is a schematic diagram of an exemplary implementation of the system;

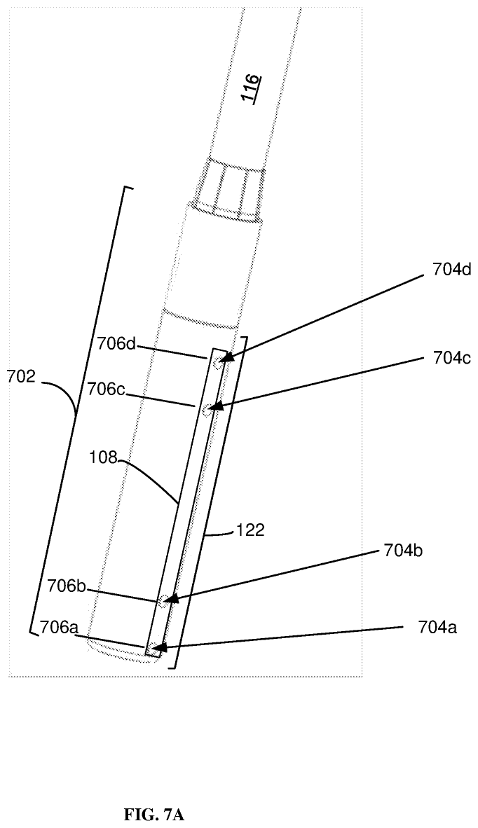

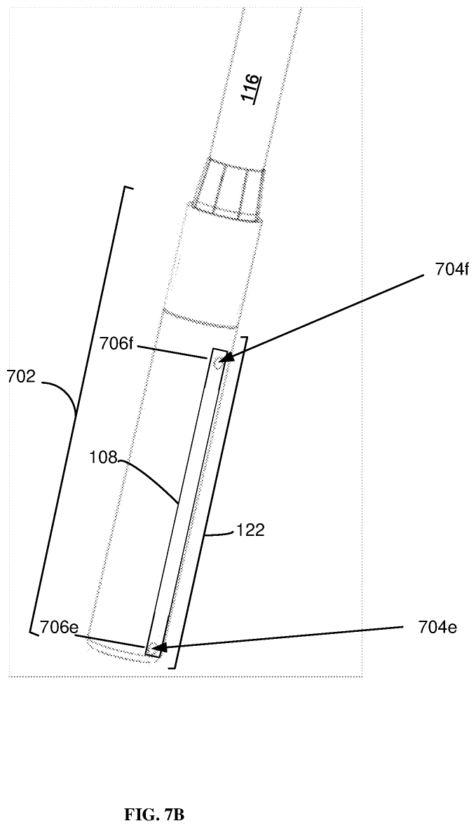

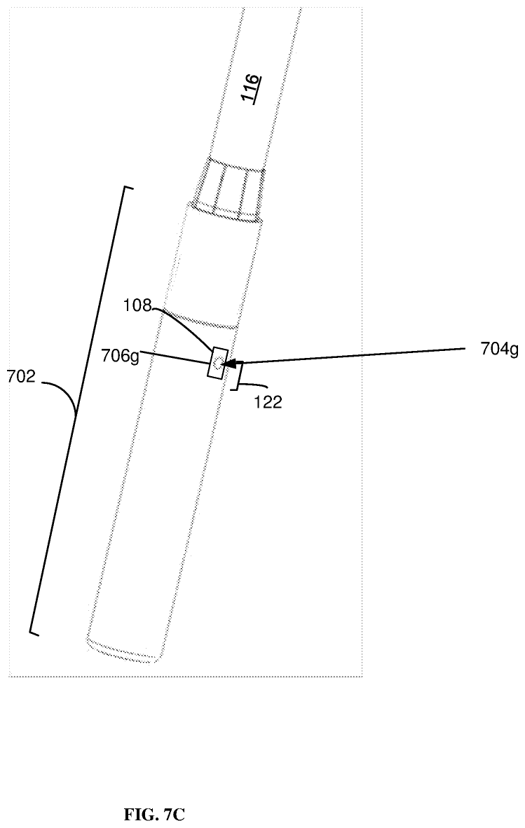

h. FIGS. 7A to 7C are diagrams of a nozzle of the hose/pipe/tube fitted with different versions of the sensor component;

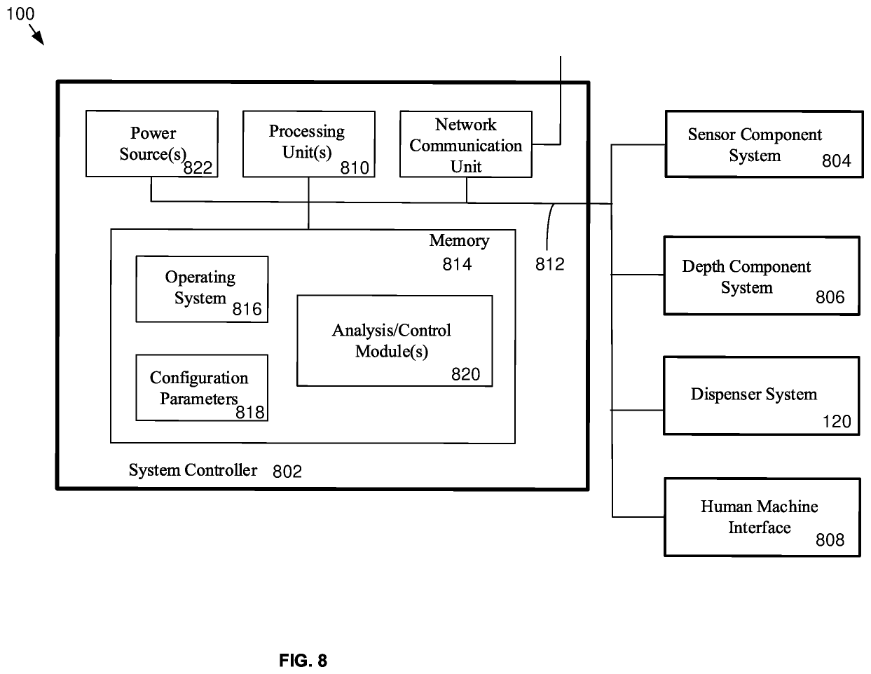

i. FIG. 8 is block diagram of the system with the system controller;

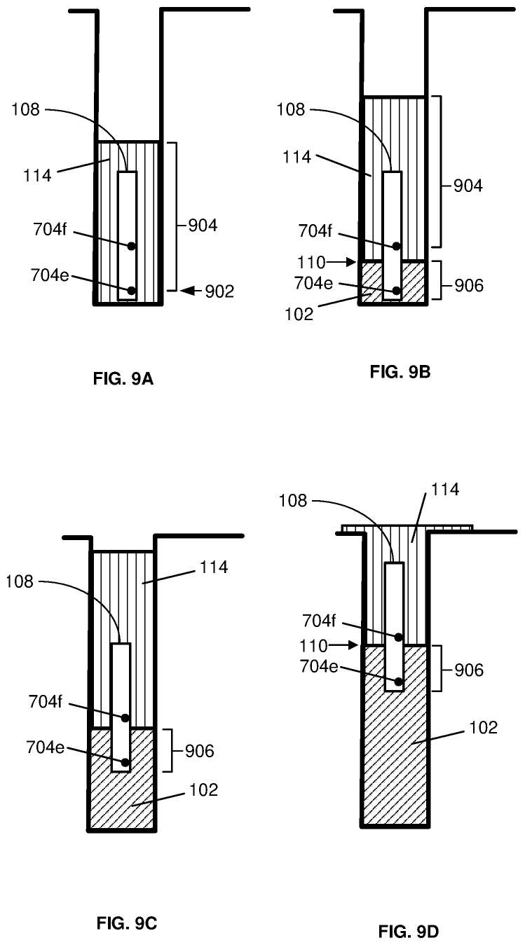

j. FIG. 9A is a cross-sectional side diagram of the sensor component with two sensors (“dual-sensor component”) at/near a closed end (e.g., bottom) of a borehole with another fluid in the borehole at the closed end;

k. FIG. 9B is a cross-sectional side diagram of the dual-sensor component at/near the closed end with the fluid explosive in/at the end and the other fluid above the fluid explosive;

l. FIG. 9C is a cross-sectional side diagram of the dual-sensor component being moved away from the closed end with the fluid explosive filling beyond/underneath the dual-sensor component (to the closed end) and the other fluid above the fluid explosive;

m. FIG. 9D is a cross-sectional side diagram of the dual-sensor component approaching the open end of the borehole with the fluid explosive filling beyond/underneath the dual-sensor component (to the closed end) and the other fluid above the fluid explosive being pushed/lifted out of the borehole;

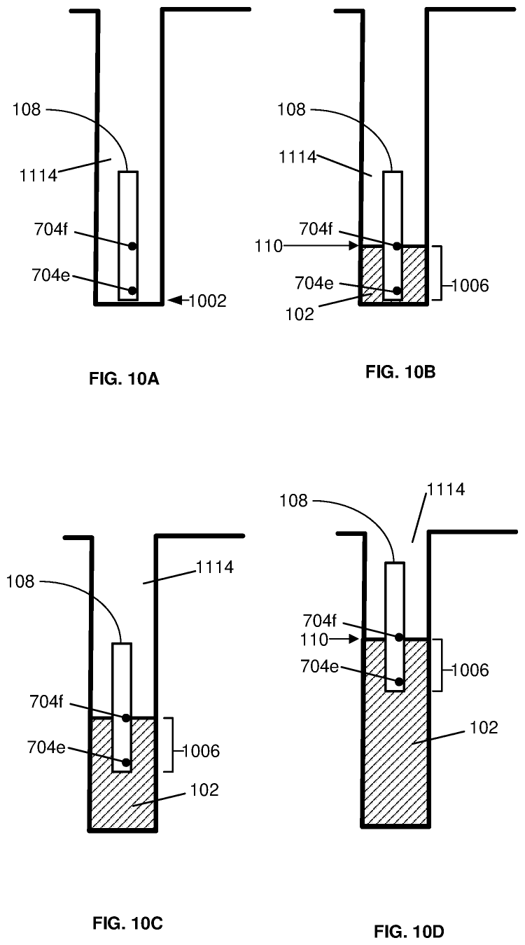

n. FIG. 10A is a cross-sectional side diagram of the dual-sensor component at/near a closed end (e.g., bottom) of a borehole with air in the borehole;

o. FIG. 10B is a cross-sectional side diagram of the dual-sensor component at/near the closed end with the fluid explosive in/at the end to at least partially immerse the dual-sensor component;

p. FIGS. 10C and 10D are cross-sectional side diagrams of the dual-sensor component being moved away from the closed end with the fluid explosive filling beyond/underneath the dual-sensor component;

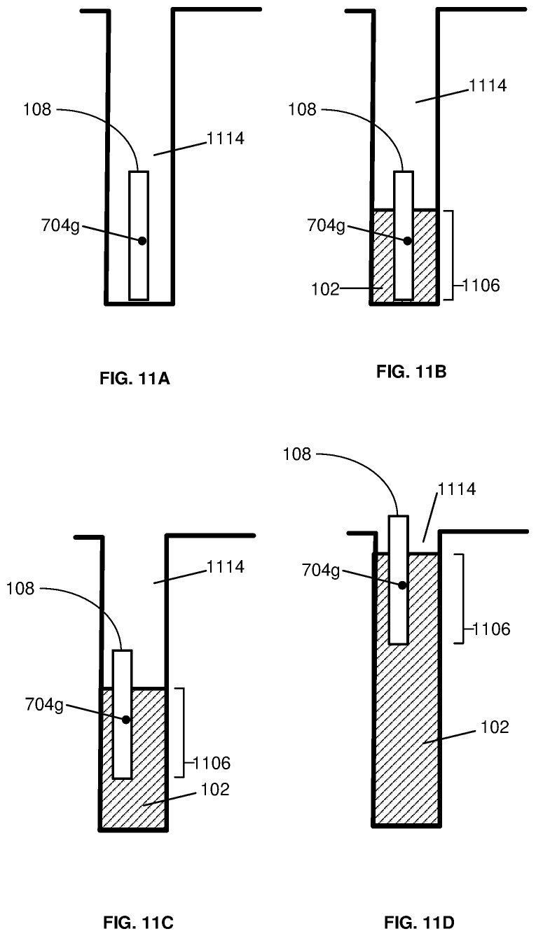

q. FIG. 11A is a cross-sectional side diagram of the sensor component with one sensor (“mono-sensor component”) at/near a closed end (e.g., bottom) of a borehole with air filling the borehole from the closed end to the open end;

r. FIG. 11B is a cross-sectional side diagram of the mono-sensor component at/near the closed end with the fluid explosive, in/at the end, at least partially immersing the mono-sensor component and the sensor;

s. FIG. 11C is a cross-sectional side diagram of the mono-sensor component being moved away from the closed end with the fluid explosive filling beyond/underneath the dual-sensor component (to the closed end) and at least partially immersing the mono-sensor component and the sensor;

t. FIG. 11D is a cross-sectional side diagram of the mono-sensor component approaching the open end of the borehole with the fluid explosive filling beyond/underneath the dual-sensor component (to the closed end) and at least partially immersing the mono-sensor component and the sensor;

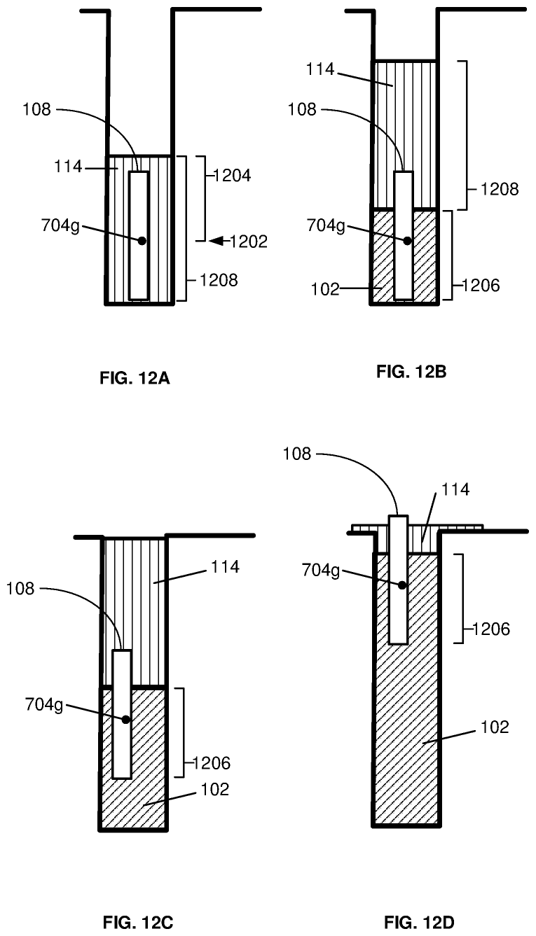

u. FIG. 12A is a cross-sectional side diagram of the mono-sensor component at/near a closed end (e.g., bottom) of a borehole with another fluid in the borehole from at/to closed end and at least partially immersing the mono-sensor component and the sensor;

v. FIG. 12B is a cross-sectional side diagram of the mono-sensor component at/near the closed end with the fluid explosive in/at the closed end (under the other fluid) at least partially immersing the mono-sensor component and the sensor;

w. FIG. 12C is a cross-sectional side diagram of the mono-sensor component being moved away from the closed end with the fluid explosive filling beyond/underneath the dual-sensor component (to the closed end, under the other fluid) and at least partially immersing the mono-sensor component and the sensor; and

x. FIG. 12D is a cross-sectional side diagram of the mono-sensor component approaching the open end of the borehole with the fluid explosive filling beyond/underneath the dual-sensor component (to the closed end, under the other fluid) and at least partially immersing the mono-sensor component and the sensor, while the other fluid is pushed/lifted out of the borehole.

### DETAILED DESCRIPTION

As shown in FIG. 1A and FIG. 1B, a system 100 for making measurements while loading fluid explosive material 102 into a borehole 104 via a fluid outlet 106 during commercial blasting operations includes a sensor component 108 configured to effectively detect/locate a location 110 of an interface 112 between: the fluid explosive material 102 (“explosive material”, or “explosive product”, e.g., an emulsion, e.g., including or based on Ammonium Nitrate Bulk Emulsion (ANE) and/or Ammonium Nitrate/Fuel Oil (ANFO) as described hereinafter) in the borehole 104; and another fluid 114 (“other fluid”), which can include a liquid, e.g., water, a gas, e.g., air, and/or an emulsion, e.g., another fluid explosive material (FEM) different from the fluid explosive material 102, optionally containing particles, e.g., dirt particles in water or prill in the FEM. The other FEM may be referred to as an “explosive material” or an “explosive product”, and may include an emulsion, e.g., including or based on Ammonium Nitrate Bulk Emulsion (ANE) and/or Ammonium Nitrate/Fuel Oil (ANFO)). The sensor component 108 is configured to monitor the location 110 of the interface 112 while the fluid outlet 106 is loading the fluid explosive material 102 into the borehole 104.

The sensor component 108 is configured to detect the location 110 of the interface 112 by measuring values of one or more fluid properties (“measured fluid properties”) of the explosive material 102 and of the other fluid 114 in the borehole 104, including bulk/macroscopic fluid properties/characteristics that relate to the bulk fluid but not a thin film thereof. The process of detection by the sensor component 108 may therefore be referred to as “measuring” and/or “monitoring” the fluid properties.

The system 100 includes a depth component configured to automatically determine a depth (“relative depth”, “R”) of the sensor component 108 in the borehole 104 relative to the fluid outlet 106 that is loading the fluid explosive material 102 into the borehole 104.

The system 100 includes an electronic system controller 802 (which may include software modules configured for processing and control, as described hereinafter) configured to automatically determine, from the measured values of the at least one fluid property and the relative depth R, whether a depth (“the outlet depth” “D”) of the fluid outlet in the explosive material, thus depth from the interface location 110, is more or less than at least one preselected distance Dsel (which can include a single preferred distance, or a minimum distance Dmin and a maximum distance Dmax, or range of distances Drange) (e.g., determining whether the fluid outlet 106 is undesirably close to or undesirably far from an upper surface of the fluid explosive material 102 in a downhole). The preselected distance Dsel can include 0.5 metres (m), and/or the preselected minimum distance Dmin (or depth) of substantially 0.05 m, and the preselected maximum distance Dmax (or depth) of substantially 1 m, and/or the preselected range Drange of 0.05 m to 1 m.

In a downhole, the interface 112 can be an upper surface of the explosive material 102, e.g., an interface between the fluid explosive material 102 in the downhole and the other fluid—which can be a mixture including the water (e.g., muddy water), the air and/or the other FEM. The other fluid is closer to the open end (e.g., top) of the borehole than the fluid explosive material 102, e.g., the other fluid is above the fluid explosive material 102 in the downhole.

The fluid explosive material 102 (which may be referred to as a “first fluid”) has a first fluid density ρ1. The other fluid 114 (which may be referred to as a “second fluid”) has a second fluid density ρ2, and the second fluid density ρ2 may be (measurably) different from the second fluid density ρ2. The first density ρ1 can refer to average density of the fluid explosive material 102 in contact with and sensed by a sensor element 122 of the sensor component 108 (described in detail hereinafter). The second density ρ2 can refer to average density of the other fluid in contact with and sensed by the sensor element 122. The measurable difference between the first fluid density ρ1 and the second fluid density ρ2 may be at least 1%, 2%, 3%, 4%, 5%, 10%, 20%, 50%, 100%, 2 times, 5 times, 10 times, 100 times, 500 times or 1000 times (wherein the higher differences may be applicable if the other fluid 114 is substantially a gas, e.g., air). In examples, the second fluid density ρ2 may be substantially 1.2 kg/m\hat{ }3 (e.g., similar to air density), substantially 1 gram/cm\hat{ }3 (e.g., similar to water density), substantially between 0.5 and 2 gram/cm\hat{ }3, substantially between 0.8 and 1.5 g/cm\hat{ }3, or substantially between 0.9 and 1.2 g/cm\hat{ }3, substantially between 0.2 and 1 g/cm\hat{ }3, substantially between 1 and 2 g/cm\hat{ }3, or substantially 0.8 gram/cm\hat{ }3 (e.g., similar to ANFO density). In examples, the second fluid density ρ2 may be substantially between 0.5 and 2 gram/cm\hat{ }3, substantially between 0.8 and 1.5 g/cm\hat{ }3, or substantially between 0.9 and 1.2 g/cm\hat{ }3, substantially between 0.2 and 1 g/cm\hat{ }3, substantially between 1 and 2 g/cm\hat{ }3, or substantially 0.8 gram/cm\hat{ }3 (e.g., similar to ANFO density), and measurably different from the second fluid density ρ2.

The fluid outlet 106 can be an outlet of a hose/pipe/tube 116 configured to extend into the borehole 104 from a hose reel/motor system 118. The system 100 includes a dispenser system 120 with the hose/pipe/tube 116 and the hose reel/motor system 118. The hose reel/motor system 118 is configured to extend and withdraw the hose/pipe/tube 116 into and from the borehole 104 at a speed/draw rate S (“withdrawal rate”, e.g., in meters per second) that is controlled/selected by the dispenser system 120, which may receive control signals from the system controller 802 to control the draw rate S. The dispenser system 120 includes fluid valves/pumps configured dispense the fluid explosive material 102 at a fill rate Q (“fluid rate”, or “delivery rate”, or “pump rate”, e.g., in cubic meters per second) of delivery of the fluid explosive material 102 from the fluid outlet 106 that is controlled/selected by the dispenser system 120, which may receive control signals from the system controller 802 to control the fill rate Q. The system 100 may include an explosive delivery apparatus (or “delivery platform”), e.g., a mobile manufacturing unit (“MMU”) or a mobile processing unit (“MPU”), with the dispenser system 120, the hose/pipe/tube 116 and the hose reel/motor system 118.

### Sensor Component

The sensor component 108 detects the fluid properties of the fluid explosive material 102 and of the other fluid 114 in the borehole 104.

The detected/monitored (or “measured”) fluid properties can include macroscopic physical properties, relating to measurable properties of the bulk fluid in the borehole, including hydrostatic properties, include pressure exerted/applied by the fluid (“p” in Pascals) to the sensor component 108.

The sensor component 108 can therefore be configured to detect/monitor/measure the pressures exerted/applied to the sensor component 108.

The sensor element 122 of the sensor component 108 can include one or more sensors of the physical property configured to each detect/measure a value of the property (“property value”) at a location (“sensing location”) defined by mounting locations and physical arrangements of the sensors.

The sensor element 122 may include two or more sensor components (operating in parallel and/or for redundancy), including one or more single-sensor components (mono-sensor component), one or more two-sensor components (dual-sensor component) and/or one or more array component, with the system 100 being configured to combine respective measurements from the two or more sensor components statistically (e.g., by averaging and/or rejecting outlier values) during operation.

The sensor element 122 can include a sensor array, which include a discrete array and/or a continuous array. The discrete array includes a plurality of discrete ones of the sensors at the respective sensor locations. The discrete array may include up to 30 or up to 40 or up to 50 sensing locations provided by discrete sensors. The continuous array includes a distributed sensor configured to measure the property values at the sensing locations defined by a mounting location and a physical arrangement of the distributed sensor. The continuous array may include one or more elongated (along the depth) distributed sensors that each measure the property values at a plurality of locations on both sides of the fluid interface 112 when in use

The sensor element 122 may be substantially linear. The sensor element 122 is configured to lie/hang at least partially longitudinally along the borehole 104 such that, when in use, one or more of the sensors can be out of the explosive material 102 and/or one or more of the sensors can be immersed in the explosive material 102; alternatively, one or two or more of the sensors can be immersed in the explosive material 102 with no sensors out of the explosive material, depending on the stage of the method of use described hereinafter. Thus, the sensor component 108 is configured to be at least partially immersed in the fluid explosive material 102 in the borehole 104 while the fluid explosive material 102 is being loaded into the borehole 104 from the fluid outlet 106.

The sensors may include pressure sensors.

The pressure sensors can include optical transducers that convert the applied pressure (applied by the fluids to the pressure sensors) into optical signals representing the applied pressure values. The continuous array may include one or more elongated optical time-domain reflectometer (OTDR) sensors.

As shown in FIG. 4A, in a first version of the sensor component (referred to herein as the “array component”, or “sensor array”), the sensors may include a plurality of discrete sensors 402a to 402f arranged in the sensor element 122. The sensor element 122 may include a selected spacing 406a to 406e (“inter-sensor spacing”) between adjacent discrete sensors 402a to 402f (thus defining the sensing locations). The selected spacing 406a to 406e may be for example substantially 4 centimetres (cm) or substantially 10 cm, or 4 cm or 10 cm on average. In an implementation, adjacent discrete sensors 402a to 402f (which define respective sensing locations) may be mutually spaced by an inter-sensor spacing 406a to 406e that can be substantially and/or on average: at least 5 mm, at least 1 cm, at most 25 cm, and/or substantially 5 cm. Alternatively, the inter-sensor spacing can be irregular/mutually different, so long as the electronic system controller 802 is configured to receive/determine/match the values from each pressure sensor with its corresponding sensor location, i.e., forming pressure-location value pairs, so the electronic system controller 802 can identify which of the sensors are proximal of the interface 112 (i.e., towards the collar of the borehole 104) and which of the sensors are distal of the interface 112 (i.e., towards the terminal end of the borehole 104 from the interface 112) when in use, and determine—from the respective sensors locations of the identified proximal/distal sensors—the location 110 of the fluid interface 112 because the fluid interface 112 lies between the locations of the sensors sensing/detecting the explosive fluid 102 versus the other fluid 114 when in use.

As shown in FIG. 4B, in a second version of the sensor component (“dual-sensor component”), the sensors may include two discrete sensors 402g and 402h arranged along the sensor element 122 spaced by an inter-sensor spacing of 406f, e.g., between 10 cm and 200 cm, including 50 cm.

As shown in FIG. 4C, in a third version of the sensor component (“mono-sensor component”), the sensors may include just one sensor 402i.

The sensors are configured to generate monitoring signals that represent the measured/detected property values. The signals can include optical (i.e., light) signals, with the information modulated onto respective wavelengths of light reflected from the pressure sensors. The signals can include electronic signals that represent the values detected by the pressure sensors. The system 100 includes a sensor component system 804 with the sensor component 108 and electrical/optical signal conductors in the form of optical fibres and wires as described hereinafter. The optical fibres and/or wires may be protected from the environment in the borehole 104 by being “ruggedized”, which may include: being housed in and/or on the hose/pipe/tube 116, e.g., embedded in, contained within, fixed to or mounted on (e.g., as shown in FIGS. 4A to 4C); and/or housed in a separate protective tube or amour, optionally including a heavy-duty optical fibre and/or optical fibre armour, e.g., an armoured optical fibre cable. The conductors can include a plurality of section/segments/portions in series, connected by join/connectors/plugs, e.g., including fibre optic connectors (e.g., ‘FC/APC’, ‘SC’, ‘LC’, or E2000 fibre optic connectors).

The monitoring signals are carried by the sensor component system to the electronic system controller 802, which is configured to process the monitoring signals to determine the respective values (including pressure measurements).

The optical transducers can include fibre optic sensors, including fibre optic pressure sensors. The fibre optic pressure sensors can each include at least one reflector or interferometer in a fibre sensor, e.g., in the form of: a fibre Bragg grating (FBG), or a Fabry-Perot interferometer.

The reflector or interferometer (e.g., including the FBG) is configured to reflect at a main wavelength (“characteristic wavelength”, e.g., “Bragg wavelength” for an FBG) that is controlled by longitudinal strain applied to the fibre sensor, and the strain is sensitive to longitudinal pressure on the fibre sensor, so the pressure applied modulates the characteristic wavelength (e.g., Bragg wavelength). Thus, the characteristic wavelength can represent the pressure applied to the fibre sensor, and changes in the pressure on the fibre sensor cause corresponding shifts in the characteristic wavelength. The sensor element 122 may include plurality of the FBGs configured with mutually different Bragg wavelengths, e.g., spaced at a selected wavelength spacing (e.g., substantially 2 nm increments) that is selected to provide at least a selected minimum dynamic range (when in use) and optionally at least the number of sensing locations (e.g., 4 or more) if all sensing locations are provided by the one optical fibre conductor (e.g., the pair of fibres) using wavelength-division multiplexing (WDM) methods/processes, thus providing mutually different ones of the monitoring signals at the respective sensing locations to the electronic system controller 802. Alternatively, or additionally to WDM of the signals, the signals from respective sensor can be differentiated using optical frequency-domain multiplexing, e.g., Optical Frequency Domain Reflectometry (OFDR), or time-domain multiplexing, e.g., Optical Time Domain Reflectometry (OTDR) methods/processes. If using the OFDR methods, the optical signal from each reflector is demultiplexed using the beat frequency between the reflector and a local reference reflector. The beat frequency is characteristic of the distance between the local reference and the sensor being monitored. If using the OTDR methods, the electronic system controller can interrogate each optical sensor with a time-domain pulse, e.g., using an optical time-domain reflectometer connected to the optical fibre portion and configured to interrogate the reflector/interferometer.

As shown in FIG. 6, the sensor component system 804 can include an optical system 600 with a light source 602 for interrogating the optical transducers, e.g., the reflectors or interferometers. The light source 602 can include a broad-spectrum light source (“broadband source”), which can be a white light source, that is configured to shine broad spectrum light along the optical fibre to the optical transducers (in the sensor component 108). The broadband source can include a light-emitting diode (LED). For a broadband source, the electronic components include a spectrometer configured to measure the wavelength shifts in the respective reflective/reflected wavelengths in the signals (which may represent respective pressure shifts or vibration signals at the sensing locations). The light source 602 can include a narrowband source, e.g., a tuneable laser source, controlled (generally by the electronic components) to measure wavelength shifts in the respective reflective/reflected wavelengths in the signals. The light source 602 can include an optical circulator 604. The light source 602 includes a sensor output 608 that connects to an optical filter 610 (which may be tuneable to select an appropriate wavelength for each transducer), and to each fibre sensor 612 via a length of optical fibre 614 that extends to the sensor component 108 in the borehole 104. The fibre sensor 612 is configured to detect the pressure applied thereto. The fibre sensor 612 includes a sensor housing (or “packaging”) that is configured to transfer the pressure from surrounding fluid to the fibre sensor while simultaneously resisting ingress of the fluid into the fibre sensor (which could damage or foul the transducer). The housing may include a fluid-resistant resilient polymer material. The optical fibre 614 carries the optical signals representing the monitoring signals from the fibre sensor 612 back along to the optical circulator 604, which is connected to an output fibre 616 configured and connected to carry the optical monitoring signals to photodetectors 618, which convert the optical signals to corresponding electrical signals. The optical system 600 includes the conductors/wires that carry the corresponding electrical signals to a digitiser 620 (an analog to digital converter) that is configured to convert the corresponding electrical signals to corresponding digital signals, and to transmit the digital signals to the system controller 802 for analysis/calculation.

The sensor component 108 may include a protective film, e.g., a Teflon film, over each sensor. The protective film is configured to be substantially resistant to the explosive fluid 102 and the other fluid 114, and optionally other elements/compounds/particles in the borehole 104 or site, thereby allowing the sensor component 108 to be reused and/or cleaned without affecting the functionality of the sensor component 108 to measure the fluid properties. The sensor component 108 may include a protective shield, e.g., a ceramic disc, over each sensor: e.g., in a fibre Bragg grating (FBG) transducer assembly. The protective shield can be configured and arranged to substantially transmit pressure through itself from the surroundings (e.g., the explosive fluid 102 or other fluid 114) to the sensor.

Each fibre sensor can include semi-rigid or rigid substrate holding the fibre portion a mounting plate in firm contact with the optical fibre portion. The mounting plate may be formed of aluminium (Al) or other suitable metallic or non-metallic material. Each fibre sensor can include a pair of fibre portions arranged in a helix in a FBG transducer assembly, e.g., from Arkwright Technologies Pty Ltd (Australia), e.g., including FBGs paired for temperature compensation.

The sensor component system 804 and/or the electronic system controller 802 can store a calibration relationship (including calibration factors) between the pressure on the optical sensors and the wavelength shifts, and use the stored calibration relationship and the measured wavelength shifts to measure the respective pressures when in use. For example, the optical sensors can be calibrated by applying a series of known pressures or dipping the sensor element into a known depth of water/emulsion and measuring the corresponding change in optical signal for each pressure or depth. The calibration factors can then be determined from the ratio of the change in an optical parameter such as the reflected wavelength and the pressure or depth applied to each sensor.

The pressure sensors can measure the respective fluid pressures (“measured fluid pressures”) in the form of quasi-static pressure values, caused by pressure applied to the pressure sensors by the fluid in which they are immersed-since pressure changes with depth dependent from average fluid density.

### Depth Component

As shown in FIGS. 2 and 3, the depth component can include a mechanical arrangement between the fluid outlet 106 and the sensor component 108 to determine (i.e., fix/set/select; and/or monitor/measure/sense) the relative depth (“R”) of the sensor component 108 such that the sensor component 108 is held/supported/fixed by the mechanical arrangement at the relative depth R when in use, typically such that an proximal/upper portion of the sensor component 108 is proximal of the interface 112 (e.g., above the upper surface in a downhole) and a distal/lower portion of the sensor component 108 is distal of the interface 112 (e.g., below the upper surface in a downhole) when in use.

The system 100 includes a depth component system 806 with the depth component and associated auxiliary components, such as signal receivers for receiving depth signals, encoders for measuring rotation and depth, and controllers for moving the depth component.

### Affixed Depth Component

As shown in FIG. 2, the mechanical arrangement can include a mount 202 that affixes (i.e., holds or fixes) the sensor component 108 to the hose/pipe/tube 116 at the relative depth R.

In this arrangement, the depth component determines the relative depth R (of the sensor component 108 in the borehole 104 relative to the fluid outlet 106) by affixing the sensor component 108 to the hose/pipe/tube 116.

The mount 202 can include a slot in the hose/pipe/tube 116 (e.g., longitudinal slot 408 formed longitudinally along the hose/pipe/tube 116 shown in FIG. 4), or a strap (“strap to hose”), which is configured to receive the sensor component 108 and to hold (affix) the sensor component 108 to the hose/pipe/tube 116 when in use. The slot can guide the optical fibre and/or wires carrying the monitoring signals along the hose/pipe/tube 116.

The mount 202 can include adhesives between the sensor component 108 and the hose/pipe/tube 116. The adhesives can include a waterproof adhesive that holds the sensor component 108 to the hose/pipe/tube 116 when in use. The mount 202 may include one or more of the following fasteners to affix the sensor component 108 to the hose/pipe/tube 116: clips, a slot (e.g., longitudinal slot 408) in the hose/pipe/tube 116, fluid-resistant tape, cable ties, hose clamps, and screws. The adhesives can hold the optical fibre and/or wires carrying the monitoring signals to the hose/pipe/tube 116.

By mechanically affixing/fastening/attaching the sensor component 108 to the hose/pipe/tube 116, the sensor component 108 and the hose/pipe/tube 116 can be lowered into the borehole 104 and drawn up from the borehole 104 simultaneously, i.e., in one operation, while continuously monitoring the depth of the fluid outlet 106 below the interface 112, thus mitigating mechanical interference (e.g., mutual bumping or scraping during insertion or withdrawal) between the sensor component 108 and the hose/pipe/tube 116 in the borehole 104.

As shown in FIGS. 7A to 7C, the mechanical arrangement can include a hose nozzle 702 that can include/be fitted with the sensor component 108. The sensor component, in its first version, can include at least four sensors 704a-704d, as shown in FIG. 7A, which can be the optical sensors (e.g., the FBG sensors), spaced at pre-determined/preselected sensing locations/distances 706a-706d along the length of the nozzle 702. The sensor component, in its second version, can include at least two sensors 704e and 704f, as shown in FIG. 7B, which can be the optical sensors, spaced at the pre-determined/preselected sensing locations/distances 706e and 706f along the length of the nozzle 702. The sensor component, in its third version, can include one sensor 704i, as shown in FIG. 7C, with the optical sensor, at a pre-determined/preselected sensing location 706g adjacent to or towards a distal end of the nozzle 702. The hose nozzle 702 is removably attachable to a distal end (the end that goes into the borehole 104) of the hose/pipe/tube 116, e.g., by screw fittings.

### Separate/Independent Depth Component

As shown in FIG. 3, the mechanical arrangement can include an independent mechanical apparatus 302 that is separate and mechanically independent from the hose/pipe/tube 116 while in the borehole 104. The independent mechanical apparatus 302 is configured to move (raise/lower) the sensor component 108 independently of the fluid outlet 106, e.g., allowing the sensor component 108 to be inserted (e.g., lowered) into or withdrawn (e.g., raised) out of the fluid explosive material 102 independently of the hose/pipe/tube 116.

The independent mechanical apparatus 302 can include a line 304 and a line-driving mechanism 306 (which may include a lifting mechanism). The line 304 may be configured to support longitudinal tension (e.g., for a downhole) or both longitudinal tension and compression (e.g., for an uphole), and may include a rope/cable for a downhole, or a rod or series of rods, or a flexible rod for an uphole. The line 304 is configured to hold the sensor element 122 at least partially submerged in the fluid explosive material 102 in the borehole 104 (to continuously monitor the depth/location of the interface 112). The line-driving mechanism 306 (e.g., a motorised reel) is configured to extend and retract (e.g., lower and raise for a downhole) the sensor component 108 via the line 304 to maintain the relative depth R separately from, but simultaneously with, extension/retraction of the hose/pipe/tube 116 when in use. Line adhesives and/or a protective cover can hold the optical fibre and/or wires carrying the monitoring signals to the line 304.

The depth component can be configured to measure the relative depth R (e.g., by measuring a length (“line length” L1) of the line 304 from the line-driving mechanism 306 in the borehole and a length (“hose length” L2) of the hose/pipe/tube 116 in the borehole 104), and/or to dynamically maintain the relative depth R by controlling the line-driving mechanism 306 to dynamically/continuously maintain the relative depth R when in use.

The independent mechanical apparatus 302 may include an encoder on the line-driving mechanism 306 configured to measure line length L1 (representing the depth of the sensor component 108). The encoder is configured and connected to the system controller 802 to send the depth measurement (based on the line length L1), which (together with the hose length L2) represents the relative depth R. The dispenser system 120 is configured to measure the hose length L2, e.g., by way of an encoder in/on the hose reel/motor system 118.

Providing a depth component that is lowered/raised separately and independently of the hose/pipe/tube 116 may avoid the need to affix the sensor component 108 to the hose/pipe/tube 116, which may be easier in some instances.

### Electronic Components

As shown in FIG. 8, the system 100 includes the electronic system controller 802, the sensor component system 804 (with the sensor component 108 and sensor electronics that provide the monitoring signals for the system controller 802), the depth component system 806 (with the depth component), the dispenser system 120 (including control systems configured to control the fill rate Q and the draw rate S based on control signals, including feedback signals from the system controller 802), and a human-machine interface (HMI) 808.

As shown in FIG. 8, the system controller 802, which may be part of or integrated into the control system of the explosive delivery apparatus (e.g., MMU/MPU), includes:
a. at least one processing unit 810 in communication (via a data bus 812 and communications protocols) with: the sensor component system 804 to receive the monitoring signals; the depth component system 806 to receive any depth indication signals representing the relative depth R; the dispenser system 120 to send feedback signals to control the fill rate Q and the draw rate S; and the HMI 808 to display/play information/alerts to the operator;
b. a memory unit 814, in communication with the processing unit 810, that stores a plurality of operational modules in the form of machine-readable code, including: (1) an operating system 816, e.g., a version of Windows™; (2) configuration parameters 818 stored as persistent data (e.g., the calibration relationship and calibration factors between the pressure on the optical sensor and the wavelength shifts); and (3) analysis/control modules 820 that are read and executed by the processing unit 810 to perform the operations of the system controller 802; and
c. at least one power source 822, e.g., the power supply of the explosive delivery apparatus, configured to power the system controller 802.

The at least one processing unit 810 (which includes at least one microprocessor or microcontroller and a general-purpose input-output unit) and the memory unit 814 may include semiconductor chips configured for operation as described herein.

The electronic system controller 802 (by way of the analysis/control modules 820 controlling the processing unit 810) can be configured to determine whether an amount of the fluid explosive material 102 delivered into the borehole 104 is approaching a preselected fill volume and/or a preselected fill depth in the borehole 104, e.g., based on the preselected fill volume/depth in a blast plan/blasting plan. The electronic system controller 802 (by way of the analysis/control modules 820 controlling the processing unit 810) may receive a measure of the delivered volume (from the dispenser system 120 of the explosive delivery apparatus) and/or a measure of the length L2 of the hose/pipe/tube 116 extending in the borehole (from the dispenser system 120, optionally from the hose reel/motor system 118) and compare the delivered volume and/or the delivered depth to the preselected fill volume and/or fill depth respectively, to determine that an end-of-fill is being approached. The electronic system controller 802 (by way of the analysis/control modules 820 controlling the processing unit 810) may be configured to generate the feedback signals for the dispenser system 120 indicative of the end-of-fill being approached so the dispenser system 120 can reduce/taper the fill rate Q before stopping the fill. The electronic system controller 802 (by way of the analysis/control modules 820 controlling the processing unit 810) can thus be configured to direct the dispenser system 120 to reduce/slow down the fill rate Q as the end-of-fill is approached, even when the top surface of the fluid explosive material 102 is occluded by water.

The HMI 808 (including a visual user interface (UI)) is configured to indicate to the human operator whether the fluid outlet 106 is more or less than the preselected distance (or range of distances) from the interface 112 (e.g., above the preselected minimum distance and/or below the preselected maximum distance). The HMI 808 can include a visual display (e.g., with lights and/or a computer screen) and/or an audible display (e.g., configured to generate tones and/or speech).

The electronic system controller 802 (by way of the analysis/control modules 820 controlling the processing unit 810) may be configured to:
a. generate a first visual/audible alert in the HMI 808 when the fluid outlet 106 is determined to be more or less than the preselected distances;
b. generate a second visual/audible alert in the HMI 808 when the end-of-fill is being approached;
c. generate a third visual/audible alert in the HMI 808 indicative of overfilling, e.g., if the hose withdrawal rate S drops below a predetermined minimum rate Smin for a constant fill rate, e.g., indicting a void or pump failure; and
d. automatically generate the feedback signals to directly control the hose withdrawal rate S and/or the fill rate Q, e.g., to stop/reduce the fill rate Q if the hose withdrawal rate S drops below a predetermined minimum rate Smin for a constant fill rate.

The electronic system controller 802 (by way of the analysis/control modules 820 controlling the processing unit 810) can be configured to generate an alert signal if the fill rate Q or the draw rate S is above or below preselected desirable rate limits (including a desirable fluid rate range and a desired draw rate range, or the predetermined minimum rate Smin), including over a period of time (i.e., based on respective an automatic numerical integrations/summations of the fill rate Q or the draw rate S). The alert signal can be sent to the dispenser system 120 to automatically stop the fill rate Q and the draw rate S and/or notify the operator via the HMI 808. The preselected desirable rate limits may be selected by the operator using the HMI 808.

The electronic system controller 802 (by way of the analysis/control modules 820 controlling the processing unit 810) and/or electronic components of the sensor component system 804 are configured to demodulate the monitoring signals to determine the property values, e.g., pressure measurements. The analysis/control modules 820 may be configured to combine respective measurements from the two or more sensor components statistically, e.g., by averaging and/or rejecting outlier values, to avoid/mitigate measurement errors from a subset of the sensors (if plurality sensors are operating).

The analysis/control modules 820 can include at least one module configured to control the processing unit to calculate/determine whether to increase the fill rate Q, decrease the fluid rate Q, or stop the fill rate Q (i.e., Q=0), and whether increase the draw rate S, decrease the draw rate S, or stop the draw rate S (i.e., S=0). The analysis/control modules 820 can include at least one module configured to control the processing unit 810 to send the feedback signals to the dispenser system 120 based on the rates Q,S calculated/determined by the analysis/control modules 820. The electronic system controller 802 (by way of the analysis/control modules 820 controlling the processing unit 810) can be configured to indicate to the dispenser system 120 (by sending the feedback signals) if the fluid outlet 106 is more than the preselected distance Dsel from the interface 112. For example, for a downhole, the system controller 802 can indicate if the fluid outlet 106 above the preselected minimum distance (or depth) from the interface 112, thus indicating that the fluid outlet 106 is undesirably close to the interface 112, and/or if the fluid outlet 106 is below the preselected maximum distance (or depth) from the interface 112, thus indicating that the fluid outlet 106 is undesirably far from the interface 112. The electronic system controller 802 (by way of the analysis/control modules 820 controlling the processing unit 810) can be configured to determine if the fluid outlet 106 is more than the preselected distance (or range of distances) from the interface 112 comparing first measurements of the proximal sensors representing values proximal of the interface 112 (e.g., above the fluid explosive material 102 in a downhole) and second measurements of the distal sensors representing values distal of the interface 112 (e.g., in the fluid explosive material 102 in a downhole). The system controller 802 (by way of the analysis/control modules 820 controlling the processing unit 810) is configured to perform the comparison process between the measured/calculated/monitored depth D of the fluid outlet 106 and the preselected distance Dsel, and then to respond to the difference (e.g., Dsel—D) to determine/calculate/select the draw rate S and/or the fill rate Q, and/or hose position for the hose/pipe/tube 116, and to send the determined/calculated/selected withdrawal rate S, the fill rate Q, and/or the hose position to the dispenser system 120 to control the hose reel/motor system 118. The electronic system controller 802 may be configured to calculate/estimate values for the feedback signals using a feedback controller, e.g., a proportional-integral-derivative controller (PID controller), that generates stable control values for the dispenser system 120. The dispenser system 120 may be configured to respond to the feedback signal by increasing/decreasing the draw rate S and/or the fill rate Q to bring the fluid outlet 106 back to within the preselected distance Dsel. The system controller 802 can thus control the hose reel/motor system 118 of the dispenser system 120 to adjust the withdrawal rate S and/or hose position to match the determined/calculated/selected withdrawal rate S and/or hose position. The system controller 802 can thus automatically control the dispenser system 120 to control the draw rate S and/or the fill rate Q to bring the fluid outlet 106 back to within at least one preselected distance Dsel, thus applying the feedback signal to the dispenser system 120 to keep the interface 112 substantially at/within the preselected distance Dsel from the interface 112. In other words, the dispenser system 120 is configured to control the fill rate Q (e.g., by controlling the one or more pumps of the dispenser system 120 of the explosive delivery apparatus) and/or the draw rate S at which the hose/pipe/tube 116 is drawn from borehole 104 while delivering the fluid explosive material 102 (e.g., by controlling one or more reels of the hose reel/motor system 118 of the explosive delivery apparatus). The system controller 802 (by way of the analysis/control modules 820 controlling the processing unit 810) is configured to signal/control the dispenser system 120 (by sending the automated feedback signals) to increase the fill rate Q and/or reduce the draw rate S when the fluid outlet 106 is determined to be proximal of the preselected minimum distance; and/or reduce the fill rate Q and/or increase the draw rate S when the fluid outlet 106 is determined to be distal of the preselected maximum distance.

The electronic system controller 802 (by way of the analysis/control modules 820 controlling the processing unit 810) can be configured to indicate to a human operator (via the HMI 808) if the fluid outlet 106 is more than the preselected distance Dsel from the interface 112.

With the first version of the sensor component, the electronic system controller 802 (by way of the analysis/control modules 820 controlling the processing unit 810) may be configured to distinguish whether each of the sensors is proximate or distal of the fluid interface (e.g., above or below the fluid interface in a downhole), and thus determine the location 110 of the interface 112 (relative to the locations sensor component 108), i.e., determine sensor element depth B of the sensor element 122 relative to a selected registration point/level along the sensor element 122 (thus the value of the sensor element depth B represents actual depth of the element 122 in the fluid explosive material 102, and the value of the sensor element depth B may be positive or negative depending on selection of the selected registration point/level relative to a distal end of the sensor element 122 in the fluid explosive material 102), e.g., as shown in FIG. 1A. The electronic system controller 802 (by way of the analysis/control modules 820 controlling the processing unit 810) is configured to use the determined sensor element depth B and the determined relative depth R (which is fixed and/or measured by the depth component as described hereinbefore) to continuously/periodically/repeatedly determine/estimate/measure the outlet depth D (or “fluid depth”) between the fluid outlet 106 and the fluid interface 112 (e.g., upper surface of the fluid explosive material 102 in a downhole). The electronic system controller 802 is configured to determine the outlet depth D based on a numerical sum or difference between the relative depth R and determined sensor element depth B, e.g., D=R+/−B, depending on whether the selected registration point/level is above or below the desired depth Dsel, e.g., for a registration point/level selected to be at the depth of the outlet 106, the relative depth R is zero.

The first measurements may represent a first pressure gradient and second measurements may represent a second pressure gradient. The electronic system controller 802 may be configured to determine two density lines from the pressure measurements (detected by the sensors along the element 122 when oriented substantially longitudinally along the borehole 104, e.g., used vertically), and to determine an intersection location between the two density lines, and to determine that this intersection location defines the fluid interface location 110 between the two materials of differing density (including the two measurably different densities ρ1 and ρ2), which are the first fluid and the second fluid, e.g., the emulsion and the water, the emulsion and the air, the emulsion and the other FEM, and/or the water and the air.

The first pressure gradient and the second pressure gradient may be represented by respective versions of an equation describing a linear relationship between pressure and depth, i.e.,

$$Y = {M}_{i} X + {C}_{i}$$

where “i” is proximal of (e.g., above) the interface 112 in one version (i=1), where “i” is distal of (e.g., below) the interface 112 in the other version (i=2).

The interface location 110 (“X”) along the sensor element 122 can be determined by the system controller 802 (by way of the analysis/control modules 820 controlling the processing unit 810) as where the first pressure gradient intersects with the second pressure gradient (i.e., where “Y”=“Y”), as shown in the combined and rearranged equation:

$$X = \frac{( {C}_{2} - {C}_{1} )}{( {M}_{1} - {M}_{2} )}$$

where the interface location (“X”) depends from the first pressure gradient (slope and location relative to the sensor array) intersects with the second pressure gradient (slope and location relative to the sensor array). From the interface location “X” relative to the location of the sensor component 108, the electronic system controller 802 (by way of the analysis/control modules 820 controlling the processing unit 810) is configured to determine the sensor element depth B relative to the selected registration point/level along the sensor element 122.

In an example, as shown in FIG. 5, which is a graph of sensor measurement (of pressure) versus sensor location (on the sensor component) for example measurements from an exemplary implementation of the system, and in which the X axis (“sensor number”) is correlated to a position of the sensor on the array and hence has a known relationship to the fluid level distance, an average pressure gradient in the water can be substantially and measurable different from average pressure gradient in the ANE. The system controller 802 (by way of the analysis/control modules 820 controlling the processing unit 810) can be configured to determine/calculate which of the sensing locations fit the first pressure gradient and which fit the second pressure gradient, and thus determine/calculate which sensing locations lie between the two gradients, and thus determine/calculate the location of the interface 112 relative to the sensing locations.

With the second and third version of the sensor component—with two sensors (“dual-sensor component”) and with one sensor (“mono-sensor component”)—the electronic system controller 802 (by way of the analysis/control modules 820 controlling the processing unit 810) is configured to select/determine/control the draw rate S and the fill rate Q as described hereinafter with references to FIGS. 9A to 12D.

### Boreholes

The borehole 104 can have a diameter of substantially 40 mm to 400 mm, and a depth of substantially 4 m to 200 m. The borehole 104 may be referred to as a “blasthole”.

As shown in FIG. 1B, the borehole 104 may include a curvature or curve in the bottom/terminal third of the borehole, and maybe a fissure that can unexpectedly require additional fill.

The borehole 104 may be oriented substantially downwards, e.g., into a medium to be blasted in an aboveground mine, or somewhat/approximately substantially horizontally, e.g., in an underground mine. The borehole 104 can thus be referred to as a “downhole”, extending substantially downwards from its collar; alternatively, the borehole 104 can be an uphole, extending substantially upwards, and/or a sidehole extending substantially sideways from its collar. The other fluid can include water in a downhole. The other fluid can include air and/or another FEM in a downhole, uphole or sidehole.

### Explosive Delivery Apparatus and Materials

The fluid explosive material 102 may be referred to as “product”, e.g., a product of an MMU. The fluid explosive material 102 can include an explosive emulsion (“emulsion component”, or “bulk industrial explosive”), e.g., an Ammonium Nitrate Bulk Emulsion (ANE), e.g., Fortis™ Advantage Ammonium Nitrate Emulsion Phase (ANE), or Ammonium Nitrate/Fuel Oil (ANFO). The fluid explosive material 102 may include a mixture of liquid and solid elements, e.g., prill in an emulsion.

The system 100 can include the explosive delivery apparatus, as described hereinbefore, and the fluid valves/pumps, the hose/pipe/tube 116 and the hose reel/motor system 118, and the system controller 802 can be components of the explosive delivery apparatus. The explosive delivery apparatus can include a vehicle to transport constituents of explosives materials to the borehole 104, including the fluid explosive material 102. The explosive delivery apparatus includes delivery mechanisms to deliver the constituents to the borehole 104, including at least one auger for the delivery of dry, flowable explosive materials such as ammonium nitrate prill, and at least one pump for the delivery of liquid-form explosives materials such as the emulsion explosives. In the case of the emulsion explosives, typically a base emulsion is sensitized just before or during delivery to or into the blasthole, thus forming an example of the fluid explosive material 102. The explosive delivery apparatus includes a storage tank system for the constituents, including tanks with outlets that feed the constituents to the delivery mechanisms to form the fluid explosive material 102.

The explosive delivery apparatus may be adapted to provide an explosive composition comprising a liquid energetic material and sensitizing voids, the sensitizing voids being present in the liquid energetic material with a non-random distribution as described in WO2014201524A1 (inventors Johann Zank, Mark Stuart Rayson, Vladimir Sujansky, James Walter, Ian John Kirby, and John Cooper). The explosive delivery apparatus may include a void delivery system for producing sensitizing voids in a stream of liquid energetic material, a mixer for mixing the streams of liquid energetic material to produce the explosive composition, and a blasthole loading hose. The mixer may be provided at the end of the loading hose. The hose/pipe/tube 116 may include a hose for conveying an emulsion explosive together with an annular stream of aqueous solution around the emulsion explosive as a lubricant as described in WO2016074045A1 (inventors Su Nee Tan and Darren Morton).

### Method

Disclosed herein is a method (or “process”) for automatically monitoring loading of fluid explosive material 102 into a borehole 104 via a fluid outlet 106 during commercial blasting operations, and for making measurements while loading the fluid explosive material 102 into the borehole 104 via the fluid outlet 106 (of the hose/pipe/tube 116) during commercial blasting operations. The following methods are performed substantially automatically by the electronic system controller 802 (by way of the analysis/control modules 820 controlling the processing unit 810) controlling the depth component system 806 and the dispenser system 120 based on processing (according to the analysis/control modules 820) of the measurements from the sensor component system 804; thus, the analysis/control modules 820 are configured/arranged/programmed to control the system 100 to perform the following methods automatically/substantially automatically.

The method may include:
a. automatically determining (including sensing/measuring/monitoring) a depth B of the sensor element 122 in the fluid explosive material 102 (using the sensor element 122); and
b. automatically determining (e.g., fixing/setting/selecting, or monitoring/measuring/sensing) a relative depth R of the sensor element 122 in the borehole 104 relative to the fluid outlet 106 while it is loading the fluid explosive material 102 into the borehole 104.

The method may include: automatically distinguishing between the fluid explosive material 102 and another fluid 114 (“other fluid” or “second fluid”) in the borehole 104 to determine the sensor element depth B of the sensor element 122 in the fluid explosive material 102.

The method may include: partially immersing the sensor element 122 in the fluid explosive material 102.

The method may include: measuring values of at least one fluid property of the explosive material 102 and of the other fluid 114, determining the sensor element depth B of the sensor element in the fluid explosive material 102 based on the measured values, and determining the outlet depth D based on the sensor element depth B and the relative depth R.

The method may include: measuring the values of the at least one fluid property in the form of macroscopic physical properties, including pressures exerted/applied by the fluid explosive material 102 and by the other fluid 114 to the sensors.

The method may include:
a. using the sensor component 108 to automatically detect the presence and/or depth of the fluid explosive material 102 in the borehole 104 (“detected fluid”), wherein the sensor component 108 is affixed to the hose/pipe/tube 116 to determine the relative depth (“R”) of the sensor component 108 in the borehole 104 relative to the fluid outlet 106; and
b. determining automatically, from the detected fluid and the relative depth R, if the fluid outlet 106 is more or less than at least one preselected distance Dsel (e.g., desirable depth in the emulsion) from the interface location 110 (e.g., determining whether the fluid outlet 106 is undesirably close to or undesirably far from an upper surface of the fluid explosive material 102 in a downhole).

The method may include:
a. using the sensor component 108 configured to automatically detect the fluid explosive material 102 in the borehole 104;
b. automatically determining the relative depth R of the in the borehole 104 relative to the fluid outlet 106 that is loading the fluid explosive material 102 into the borehole 104;
c. determining automatically, from the detected fluid explosive material 102 and the relative depth R, if the fluid outlet 106 is more or less than at least one preselected distance Dsel (e.g., depth in the emulsion) from the interface location 110 (e.g., determining whether the fluid outlet 106 is undesirably close to or undesirably far from an upper surface of the fluid explosive material 102 in a downhole); and
d. automatically controlling the fill rate Q of delivery of the fluid explosive material 102 from the fluid outlet 106 and/or the draw rate S at which the hose/pipe/tube 116 is withdrawn from borehole 104 while delivering the fluid explosive material 102 to increase the fill rate Q and/or reduce the draw rate S when the fluid outlet 106 is determined to be proximal of (i.e., shallower in the fluid explosive material 102 than) the preselected minimum distance Dmin; and/or reduce the fill rate Q and/or increase the draw rate S when the fluid outlet 106 is determined to be distal of (i.e., deeper into the fluid explosive material 102 than) the preselected maximum distance Dmax.

The method may include:
a. automatically determining if the delivery fill rate Q is below a preselected threshold Qmin (representing a desired minimum flow rate of the application or implementation, selected by a person using the HMI 808); and
b. if so, automatically controlling the draw rate S to stop and/or automatically initiating an alarm.

When the sensors include pressure sensors, and the other fluid 114 is not just air (atmospheric air), the method (“dual-sensor/pressure-difference method”) may include:
a. measuring an initial/background pressure (Pi) of the other fluid 114 in the borehole at an initial depth/location 902 from a first pressure sensor 704e on the sensor component 108 when the sensor component 108, which may be the sensor component with two sensors (“dual-sensor component”), is at/near the closed end (e.g., bottom) of the borehole with the other fluid 114 in the borehole (at the closed end), as shown in FIG. 9A, wherein the initial/background pressure (Pi) represents a height 904 (or head of fluid) above the first pressure sensor 704e—the initial depth/location 902 may be selected to select a distance (“standoff distance”) between the closed end and the first pressure sensor 704e that is substantially less than the inter-sensor spacing (e.g., inter-sensor spacing 406f) so that fluid explosive material 102 can fill at least to the first pressure sensor 704e before the second pressure sensor 704f measures the initial/background pressure (Pi), thus allowing the interface location 110 to be between the first pressure sensor 704e and the second pressure sensor 704f along the sensor element 122;
b. initially filling the fluid explosive material 102 into the borehole at the closed end, without raising/drawing the sensor component 108, until the fluid explosive material 102 lifts/pushes the other fluid out of the borehole to a height where the second pressure sensor 704f measures a pressure substantially equal to the initial/background pressure (Pi), thus implying that the other fluid 114 has been pushed/lifted above the second pressure sensor 704f substantially equal to the height 904—and measuring an initial pressure difference (Pdi) between the first pressure sensor 704e and the second pressure sensor 704f when the other fluid 114 is at height 904 above the second pressure sensor 704f (the initial pressure difference (Pdi) represents the head of the fluid explosive material 102 between the first pressure sensor 704e and the second pressure sensor 704f)—when the pressure difference (Pd) between the first pressure sensor 704e and the second pressure sensor 704f is substantially equal to the initial pressure difference (Pdi), the interface location is between the first pressure sensor 704e and the second pressure sensor 704f, thus the sensor element 122 is automatically determining the depth 906 (B “sensor depth”) of the sensor element 122 in the fluid explosive material 102; and
c. further filling the fluid explosive material 102 into the borehole while raising/drawing the sensor component 108 from the borehole, and automatically controlling the fill rate Q and/or the draw rate S so that the pressure difference (Pd) is/remains substantially equal to the initial pressure difference (Pdi) during the filling, as shown in FIG. 9C, including when/if the other fluid 114 is pushed/lifted out of the borehole, thus spilling to the sides of the borehole, as shown in FIG. 9D—as the other fluid 114 spills, the pressures measured by the first pressure sensor 704e and the second pressure sensor 704f decrease (as there is less head of pressure above them from the other fluid 114), but the pressure difference (Pd) is/remains unaffected by the spilling of the other fluid, so the pressure difference (Pd) is used to automatically control filling of the fluid explosive material 102 even as the other fluid 114 spills.

When the sensors include pressure sensors, and the other fluid 114 is just air 1114 (atmospheric air), the method (“dual-sensor/pressure-difference method”) may include:
a. lowering/inserting the sensor component 108, which may be the sensor component with two sensors (“dual-sensor component”), to/near the closed end of the borehole, as shown in FIG. 10A, and measuring a pressure (which should just be air pressure) from a first pressure sensor 704e on the sensor component 108;
b. initially filling the fluid explosive material 102 into the borehole at the closed end, without raising/drawing the sensor component 108, until second pressure sensor 704f measures a substantial pressure due to the fluid explosive material 102 at least reaching the second pressure sensor 704f, as shown in FIG. 10B, thus defining/determining the depth 1006 (B “sensor depth”) of the sensor element 122 in the fluid explosive material 102—and measuring an initial pressure difference (Pdi) between the first pressure sensor 704e and the second pressure sensor 704f when the fluid explosive material 102 extends from the first pressure sensor 704e to the second pressure sensor 704f as shown in FIG. 10B (the initial pressure difference (Pdi) represents the head of the fluid explosive material 102 between the first pressure sensor 704e and the second pressure sensor 704f); and
c. further filling the fluid explosive material 102 into the borehole while raising/drawing the sensor component 108 from the borehole, and automatically controlling the fill rate Q and/or the draw rate S so that the pressure difference (Pd) is/remains substantially equal to the initial pressure difference (Pdi) during the filling, as shown in FIG. 10C and FIG. 10D.

When performing the pressure-difference methods, the initial height of the water in the borehole does not matter. The first pressure sensor 704e and the second pressure sensor 704f may measure their initial pressures before raising/drawing the sensor component 108, giving two initial pressures (Pie and Pif) and hence the pressure difference that is maintained. When Pif reaches Pie, e.g., as shown in FIG. 9B or 10B, the pumped emulsion (fluid explosive material 102) will have reached the bottom of the second pressure sensor 704f, and then the hose is withdrawn at a the rate S (and/or fill rate Q is controlled) to keep the pressure difference between the two sensors equal. When the water comes out of the borehole, as shown in FIG. 9D, the head pressure will drop but the difference remains the same.

In the pressure-difference methods, for a first fluid density (ρ1) of around 0.7 to 1.5 g/cm\hat{ }3, and the inter-sensor spacing of 406f, e.g., between 10 cm and 200 cm, the pressure difference can be substantially 100 kPa to 120 kPa, e.g., for a density of 1.2 and a height of 50 cm above the bottom sensor and 10 cm above the top sensor so in the range of 107 kPa to 102 kPa may be measured. Having the relatively sensitive pressure sensors described herein, e.g., the optical sensors, may allow for accurate measurement of such relatively small pressure variations.

When the sensors include the sensor component with one sensor (“mono-sensor component”), and the other fluid 114 is just air 1114 (atmospheric air), the method (also referred to as the “mono-sensor no-water method”) may include:
a. lowering/inserting the sensor component 108, which may be the sensor component with one sensor (“mono-sensor component”), to/near the closed end of the borehole, as shown in FIG. 11A, and setting the sensor 704g to zero (such that the pressure at the initial depth/location 1202 is measured as ‘zero’), and measuring a pressure (which should just be air pressure) from the pressure sensor 704g on the sensor component 108;
b. initially filling the fluid explosive material 102 into the borehole at the closed end, without raising/drawing the sensor component 108, until the pressure sensor 704g measures a substantial pressure due to the fluid explosive material 102 at least reaching the pressure sensor 704g (at least partially immersing the mono-sensor component and the pressure sensor 704g in the fluid explosive material 102), as shown in FIG. 11B, thus defining/determining the depth 1106 (B “sensor depth”) of the sensor element 122 in the fluid explosive material 102, wherein the measured substantial pressure is substantially equal to a precalibrated pressure representing a depth of the pressure sensor 704g in the fluid explosive material 102 (due to the first fluid density (ρ1))—wherein the precalibrated pressure is selected to define/select the depth 1106 (B “sensor depth”) required during filling; and
c. further filling the fluid explosive material 102 into the borehole while raising/drawing the sensor component 108 from the borehole, and automatically controlling the fill rate Q and/or the draw rate S so that the pressure measured by the pressure sensor 704g is/remains substantially equal to the precalibrated pressure, including with a prescribed/operational range, e.g., +/−1%, +/−2%, +/−4%, +/−5%, +/−6%, +/−7%, +/−10%, +/−12%, +/−15%, +/−17%, +/−20%, depending on implementation requirements, e.g., borehole diameter deviations, etc.—thus maintaining the sensor depth 1106 during the filling, as shown in FIG. 11C and FIG. 11D.

When the sensors include the sensor component with one sensor (“mono-sensor component”), and the other fluid 114 is not just air (atmospheric air), e.g., the other fluid 114 is water, the method (also referred to as the “mono-sensor with-water method”) may include:
a. lowering/inserting the sensor component 108, which may be the sensor component with one sensor (“mono-sensor component”), to/near the closed end of the borehole, as shown in FIG. 12A, and:
   i. measuring an initial/background pressure (Pi) of the other fluid 114 in the borehole at an initial depth/location 1202 of the pressure sensor 704g, wherein the initial/background pressure (Pi) represents a height 1204 (or head of fluid) above pressure sensor 704g—this measuring of the initial/background pressure (Pi) may include or be effected by setting the pressure sensor 704g to zero (such that the pressure at the initial depth/location 1202 is measured as ‘zero’), and the measurement are thus independent of the head of water/other fluid 114 above the pressure sensor 704g for the majority of use cases and keeps the initial method steps compatible with the mono-sensor no-water method, and
   ii. determining a total measure of total fluid height 1208 (e.g., water depth) in the bottom of the borehole based on a predetermined/set spacing/length between the pressure sensor 704g and the distal end of the sensor component 108 physically touching/reaching the closed end—the total measure may include a height and/or a pressure value (e.g., total fluid pressure due to the total fluid height 1208 for a predetermined fluid, e.g., water, with the second fluid density (ρ2));
b. initially filling the fluid explosive material 102 into the borehole at the closed end, without raising/drawing the sensor component 108 (e.g., pumping emulsion to a predetermined pressure that is to be maintained during the further filling), and:
   i. measuring the rate of pressure change at the pressure sensor 704g as a function of fill rate, and filling until the rate of pressure change substantially changes from a first rate (due substantially to the other fluid 114 being lifted above the pressure sensor 704g, thus building a head of pressure at a rate due to the second fluid density (ρ2)) to a second rate (due substantially to the fluid explosive material 102 being lifted above the pressure sensor 704g, thus building a head of pressure at a rate due to the first fluid density (ρ1), which increases at the second rate due to the fluid explosive material 102 filling), and/or
   ii. until the pressure sensor 704g measures a substantial pressure due to the fluid explosive material 102 at least reaching the pressure sensor 704g (at least partially immersing the mono-sensor component and the pressure sensor 704g in the fluid explosive material 102), in addition to the determined total fluid pressure due to the total fluid height 1208, as shown in FIG. 12B, thus defining/determining the depth 1206 (B “sensor depth”) of the sensor element 122 in the fluid explosive material 102, wherein the measured substantial pressure is substantially equal to a precalibrated pressure representing a depth of the pressure sensor 704g in the fluid explosive material 102 (due to the first fluid density (ρ1)) plus the determined total fluid pressure of the other fluid 114 above the fluid explosive material 102—wherein the precalibrated pressure is selected to define/select the depth 1106 (B “sensor depth”) required during filling as described for the mono-sensor no-water method;
c. further filling the fluid explosive material 102 into the borehole while raising/drawing the sensor component 108 from the borehole, and automatically controlling the fill rate Q and/or the draw rate S so that the pressure measured by the pressure sensor 704g (“Pg”) is/remains substantially equal to the precalibrated pressure added to the determined total fluid pressure as described for the no-water method (thus maintaining the sensor depth 1106 during the filling, as shown in FIG. 12C); and
d. if any substantial spill of the other fluid 114 occurs, e.g., if the stemming depth is less than the total fluid height 1208, as shown in FIG. 12D, the pressure measured by the pressure sensor 704g will reduce as the fluid explosive material 102 is further filled, until the pressure measured by the pressure sensor 704g is substantially different from (generally less than) the precalibrated pressure added to the determined total fluid pressure, thus the Pg is no longer in the prescribed/operational range (which would be equivalent to the sensor element 122 rising too high in the explosive material 102 or fluid 114, which would normally automatically increase the fill rate Q and/or reduce the draw rate S; however, due to the loss of the head of pressure at the top of the whole, the pressure measured by the pressure sensor 704g cannot be returned within the prescribed/operational range being substantially equal to the precalibrated pressure added to the determined total fluid pressure), in which case, the system automatically selects/controls the fill rate Q and/or the draw rate S so that the rate of pressure drop measured by the pressure sensor 704g is maintained substantially proportionally to the rate of hose withdrawal (e.g., if there is a change in rate of the pressure drop (or increase), then emulsion is not being pumped in fast enough and the pump is increased (or decreased)), and the dispenser system 120 is automatically stops the pumping/fill rate Q when the electronic system controller 802 (by way of the analysis/control modules 820 controlling the processing unit 810) indicates to the dispenser system 120 that a correct/planned depth of loading has been achieved in the borehole according to the preselected fill volume/depth in the blast plan/blasting plan.

In the mono-sensor methods, the precalibrated pressure is be pre-selected based on the first fluid density (ρ1) of the fluid explosive material 102 (or “product”) determined prior to the loading/filling. The first fluid density (ρ1) of the product at time of loading is likely in the realm of 1.1 to 1.3 times water density, or in some implementations 0.5 to 1.5 times water density, and the depth 1106 (B “sensor depth”) may be selected to be from substantially 0.5 m to substantially 1 m. For example, for a first fluid density (ρ1) of around 0.7 to 1.5 g/cm\hat{ }3, and a column depth above the pressure sensor of 10 cm to 100 cm (i.e., the selected depth of immersion of the pressure sensor in the fluid explosive material 102 during pumping), the precalibrated pressure is selected to be between 100 kPa and 120 kPa, e.g., substantially 107 kPa or 104 kPa.

When using the mono-sensor with-water method, if the fluid explosive material 102 (emulsion) flows into a void in the borehole during the further filling, and if the pressure falls (rapidly/substantially) below the prescribed/operational range due to the void, the electronic system controller 802 (by way of the analysis/control modules 820 controlling the processing unit 810) automatically detects that the pressure measured by the pressure sensor 704g is substantially different from (generally less than) the precalibrated pressure (thus outside the prescribed/operational range), and the system controller 802 substantially slows the draw rate S (with necessarily reducing or increasing the fill rate Q) to a slower draw rate S for a preselected/predefined “void time”, e.g., between 5 seconds and 120 s, or 10 s to 60 s, or 30 s, after which the system controller 802 determines that the measured pressure is back within the prescribed/operational range (typically because the void has been filled), or that an alarm/alert is required, which causes the system controller 802 to stop/pause the draw rate S and the fill rate Q and to alert the human operator, e.g., by controlling the HMI 808.

When the sensors include one or more pressure sensors (including the mono-sensor component, the dual-sensor component, and/or the array component), and the other fluid 114 is not just air (atmospheric air), additionally/alternatively to determining the total measure of total fluid height 1208 based on pressure (as described hereinbefore), the system/method may include measuring the total fluid height 1208 as the sensor component is lowered into the borehole while measuring the pressure at the one or more sensors, including:
a. at least a first pressure/density measurement and a corresponding first depth measurement (i.e., at the depth of the first pressure measurement, thus forming a first pressure/depth measurement pair as the sensor component 108 is lowered/inserted into the borehole) when the measured rate of pressure change with depth (and thus density the second fluid density (ρ2), where the second fluid it not just air) is first substantially above that due to the air pressure (which is due to the air density) as the pressure sensors are lowered/inserted into the borehole (thus measuring substantially a depth into the borehole of the top of the other fluid 114, e.g., water); and
b. at least a second depth measurement when the sensor component 108 reaches the closed end of the borehole, which can be simply when the sensor component 108 is no longer being lowered by the line-driving mechanism 306 or the hose reel/motor system 118, thus a depth due to extension of the line-driving mechanism 306 or the hose reel/motor system 118 from the first depth measurement; and
c. optionally one or more intermediate pressure/depth measurement pairs as the sensor component 108 is lowered/inserted into the borehole, and using such intermediate measurement pairs to correct for errors in the first pressure/depth measurement pair, e.g., by determining a change/inflection point in the pressure gradient as described hereinbefore; and
d. calculating/determining/estimating the total fluid height 1208 based on the difference between the first depth measurement (at the top of the other fluid 114) and second depth measurement (when the pressure sensor is at its initial depth/location (e.g., 1202).

The additional measurement of the total measure of total fluid height 1208 based on the one or more pressure/depth measurement pairs can be used by the system controller 802 (by way of the analysis/control modules 820) with the total measure of total fluid height 1208 based on pressure to mitigate errors from either measurement techniques, e.g., by automatically averaging or detecting outlier measurements.

### Implementations

Implementations of the system and method disclosed herein may solve the problem of determining outlet depth D in the borehole 104 by: using the sensor element 122. The sensor element 122 is partially immersed in the fluid explosive material 102 in use. The sensors are configured to measure values of at least one fluid property of the explosive material 102 and of the other fluid 114, and the system 100 is configured to determine the sensor element depth (B) of the sensor element in the fluid explosive material 102 based on the measured values, and the system 100 is configured to determine the outlet depth D based on the sensor element depth B and the relative depth R.

Implementations of the system and method disclosed herein may solve the problem of emulsion fouling sensor by: measuring the bulk/macroscopic physical properties of the bulk fluids, including using pressure sensors that are configured in to measure one or more pressure values, differences and/or gradients that are not affected by layers of fouling on the sensors.

Implementations of the system and method disclosed herein may perform better than systems based on ultrasonics or radar, which can suffer signal degradation due to narrow diameters and long lengths of typical boreholes, and which can be unreliable due to water being present in the borehole. Implementations of the system and method may perform better than volumetric measurement systems, which can be unreliable due irregular and inconsistent borehole cross-sections, e.g., varying hole diameter along the length of the borehole, and voids and cracks in the borehole. The pressure sensors may be able to distinguish between thin film coatings of fluid explosive material, on the pressure sensor itself, and a bulk product, in which the pressure sensor is immersed, which can be relevant for sticky fluid explosive materials that may foul other sensor types. Other sensor types may operate non-optimally when exposed to the sticky fluid explosive and/or water in the borehole, e.g., sensors with orifices may be fouled and water may block infrared signals. The optical sensors in the sensor element may provide a control level with centimetre accuracy. Using optical sensors may mitigate risks of unintentional ignition.

Implementations of the system and method disclosed herein may include two or more of the disclosed sensor components to provide redundancy of the measurements to mitigate ill effects of sensor damage and/or spurious measurements from one sensor.

Implementations of the system and method may be used for automation of explosive loading.

The electronic system is configured to determine two density lines from the pressure measurements detected by the elements along the array when used vertically, and to determine an intersection location between two density lines, and the intersection location defines the fluid interface location between the two materials of differing density.

Using the example first pressure gradient (slope and location relative to the sensor array) intersects with the example second pressure gradient (slope and location relative to the sensor array) in the graph in FIG. 3, an exemplary electronic component determined an example interface location (“X”) of 17.6 cm along the exemplary sensor array which was in reasonable agreement with the observed location of the fluid interface of 19 cm.

### Interpretation

Herein, reference to one or more embodiments, e.g., as various embodiments, many embodiments, several embodiments, multiple embodiments, some embodiments, certain embodiments, particular embodiments, specific embodiments, or a number of embodiments, need not or does not mean or imply all embodiments.

The FIGs. included herewith show aspects of non-limiting representative embodiments in accordance with the present disclosure, and particular structural elements shown in the FIGs. may not be shown to scale or precisely to scale relative to each other.

The depiction of a given element or consideration or use of a particular element number in a particular FIG. or a reference thereto in corresponding descriptive material can encompass the same, an equivalent, an analogous, categorically analogous, or similar element or element number identified in another FIG. or descriptive material associated therewith. The presence of “/” in a FIG. or text herein is understood to mean “and/or” unless otherwise indicated. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “essentially all” or “substantially” can indicate a percentage greater than or equal to 90%, for instance, 92.5%, 95%, 97.5%, 99%, or 100%.

Many modifications will be apparent to those skilled in the art without departing from the scope of the present invention.

Throughout this specification and the claims that follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

1. A system including:
a sensor component with a sensor element including at least one sensor configured to automatically determine a depth (“sensor element depth”) of the sensor element in fluid explosive material in a borehole; and
a depth component configured to automatically determine a relative depth of the sensor element in the borehole relative to a fluid outlet while the fluid outlet is loading the fluid explosive material in the borehole.

2. The system of claim 1, wherein the system is configured to automatically determine a depth (“the outlet depth”) of the fluid outlet in the fluid explosive material based on the sensor element depth and the relative depth.

3. The system of claim 1, wherein the sensor element is configured to be at least partially immersed in the fluid explosive material in use.

4. The system of claim 1, wherein the sensor element includes at least one sensor or a plurality of sensors including two sensors or more than two sensors.

5. The system of claim 1, wherein each sensor is configured to distinguish between the fluid explosive material and another fluid (“other fluid”) in the borehole to determine the sensor element depth.

6. The system of claim 5, wherein the fluid explosive material has a first fluid density and the other fluid has a second fluid density that is different from the first fluid density, and/or wherein other fluid includes water, air and/or another fluid explosive material (FEM).

7. The system of claim 5, wherein the sensors are configured to measure values of at least one fluid property of the explosive material and of the other fluid, and the system is configured to determine the sensor element depth based on the measured values.

8. The system of claim 7, wherein the sensor element is configured to measure the values of the at least one fluid property in the form of a macroscopic physical property that is not affected by layers of fouling on the sensor element.

9. The system of claim 8, wherein the macroscopic physical property includes pressures exerted/applied by the fluid explosive material and/or by the other fluid to the sensor element, and wherein the sensors include pressure sensors.

10. The system of claim 9, wherein the pressure sensors are configured in the sensor element to measure at least one pressure gradient along the sensor element.

11. The system of claim 1, wherein the depth component is configured to automatically determine the relative depth by:
fixing/setting/selecting the relative depth; or
monitoring/measuring/sensing the relative depth.

12. A method including:
a. determining a depth (“sensor element depth”) of a sensor element in a fluid explosive material in a borehole; and
b. automatically determining a relative depth of the sensor element in the borehole relative to a fluid outlet while the fluid outlet 106 is loading the fluid explosive material in the borehole.

13. The method of claim 12, including automatically determine a depth (“the outlet depth”) of the fluid outlet in the fluid explosive material based on the sensor element depth and the relative depth.

14. The method of claim 12, including partially immersing the sensor element in the fluid explosive material.

15. The method of claim 12, including automatically distinguishing between the fluid explosive material and another fluid (“other fluid”) in the borehole to determine the sensor element depth.

16. The method of claim 15, wherein the fluid explosive material has a first fluid density and the other fluid has a second fluid density that is different from the first fluid density, and/or wherein the other fluid includes water, air and/or another fluid explosive material (FEM).

17. The method of claim 15, including performing the distinguishing between the fluid explosive material and the other fluid at a plurality of sensing locations along the sensor element.

18. The method of claim 15, including measuring values of at least one fluid property of the explosive material and of the other fluid, and automatically determining the sensor element depth based on the measured values.

19. The method of claim 18, wherein the values of the at least one fluid property are in the form of values of a macroscopic physical property that is not affected by layers of fouling on the sensor element.

20. The method of claim 19, wherein the macroscopic physical property includes pressures exerted/applied by the fluid explosive material and/or by the other fluid to the sensor element.

21. The method of claim 20, including measuring a pressure gradient along the sensor element.

22. The method of claim 12, including automatically determining the relative depth by:
fixing/setting/selecting the relative depth; or
monitoring/measuring/sensing the relative depth.
